(19) United States
(12) Patent Application Publication
(10) Pub. No.: US 2026/0320967 A1
(43) Pub. Date: Oct. 15, 2026

(54) ANALYSIS SYSTEM AND ANALYSIS METHOD

(71) Applicant: TOYOTA JIDOSHA KABUSHIKI KAISHA, Toyota-shi (JP)

(72) Inventors: Kazuho SAEKI, Kawasaki-shi (JP); Takuto Inoue, Nisshin-shi (JP)

(73) Assignee: TOYOTA JIDOSHA KABUSHIKI KAISHA, Toyota-shi (JP)

(21) Appl. No.: 19/466,897

(22) Filed: Feb. 2, 2026

(30) Foreign Application Priority Data
Apr. 1, 2025 (JP) 2025-060297

(51) Int. Cl. G06V 10/72; G06V 10/26; G06V 10/44

(52) U.S. Cl. CPC G06V 10/72; G06V 10/273; G06V 10/44

(57) ABSTRACT

An analysis system according to the present disclosure includes an image acquisition unit, an image correction unit, and a feature amount extraction unit. The image acquisition unit acquires a plurality of pieces of image data. The image correction unit corrects the positions of the plurality of pieces of image data such that the positions of the common portions coincide with each other. The feature amount extraction unit extracts feature amounts from the plurality of corrected image data. According to such a configuration, the analysis system according to the present disclosure can extract a feature amount from a plurality of pieces of image data while correcting a deviation that occurs when image data is captured. As a result, the analysis system according to the present disclosure can improve the extraction accuracy of the feature amount.

### CROSS-REFERENCE TO RELATED APPLICATION

This application claims priority to Japanese Patent Application No. 2025-060297 filed on Apr. 1, 2025. The disclosure of the above-identified application, including the specification, drawings, and claims, is incorporated by reference herein in its entirety.

### BACKGROUND

### 1. Technical Field

The present disclosure relates to an analysis system and an analysis method.

### 2. Description of Related Art

Japanese Unexamined Patent Application Publication No. 2024-108021 (JP 2024-108021 A) describes an information processing device that converts an atomic coordinate image into a power spectrum and performs principal component analysis on the generated power spectrum.

### SUMMARY

The information processing device described in JP 2024-108021 A performs the principal component analysis after converting an image into a power spectrum. That is, the information processing device described in JP 2024-108021 A extracts a feature amount from image data.

When a feature amount is extracted from a plurality of pieces of image data, a deviation that occurs when images are captured may be reflected in the feature amount. For example, when the principal component analysis is performed on an image captured by a fixed-point camera or the like, an unintended positional deviation of the fixed-point camera may be reflected in the feature amount.

That is, in the related art, there is a problem that, when a feature amount is extracted from a plurality of pieces of image data, the accuracy of extraction of the feature amount may decrease. JP 2024-108021 A does not disclose a technology that can solve such a problem.

The present disclosure has an object to provide an analysis system and an analysis method that can improve the accuracy of extraction of a feature amount.

An analysis system according to the present disclosure includes an image acquisition unit, an image correction unit, and a feature amount extraction unit.

The image acquisition unit is configured to acquire a plurality of pieces of image data.

The image correction unit is configured to correct positions of the pieces of image data such that positions of common portions coincide with each other.

The feature amount extraction unit is configured to extract a feature amount from the corrected pieces of image data.

With such a configuration, the analysis system according to the present disclosure can extract the feature amount from the pieces of image data while correcting a deviation that occurs when the pieces of image data are captured. As a result, the analysis system according to the present disclosure can improve the accuracy of extraction of the feature amount.

In the analysis system according to the present disclosure, the feature amount extraction unit may be configured to perform principal component analysis on the pieces of image data to extract the feature amount from the pieces of image data.

In the analysis system according to the present disclosure, the image correction unit may be configured to mask at least part of regions that do not correspond to the common portions at outer edges of the pieces of image data.

The analysis system according to the present disclosure may further include a display control unit configured to display the corrected pieces of image data for a user.

The display control unit may be configured to switch the pieces of image data to be displayed such that display positions of the common portions coincide with each other.

An analysis method according to the present disclosure includes: acquiring a plurality of pieces of image data; extracting common portions from the pieces of image data; correcting positions of the pieces of image data such that positions of the common portions coincide with each other; and extracting a feature amount from the corrected pieces of image data.

According to the present disclosure, it is possible to provide the analysis system and the analysis method that can improve the accuracy of extraction of the feature amount.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of an analysis system according to a first embodiment;

FIG. 2 is a block diagram illustrating a configuration of a server according to the first embodiment;

FIG. 3 is a block diagram illustrating a configuration of a server according to the first embodiment;

FIG. 4A is a schematic image diagram for describing an image correction unit according to a first embodiment, and is a pre-correction image;

FIG. 4B is a schematic image diagram for describing an image correction unit according to a first embodiment, and is a pre-correction image;

FIG. 5A is a schematic image diagram for describing an image correction unit according to a first embodiment, and is a corrected image;

FIG. 5B is a schematic image diagram for describing an image correction unit according to a first embodiment, and is a corrected image;

FIG. 6 is a schematic image-side view for explaining the display control unit according to the first embodiment; and

FIG. 7 is a flowchart illustrating an operation of the analysis system according to the first embodiment.

### DETAILED DESCRIPTION OF EMBODIMENTS

### First embodiment

### Configuration of the analysis system

Hereinafter, a first embodiment according to the present disclosure will be described in detail with reference to the drawings. First, the configuration of the analysis system according to the present embodiment will be described in detail.

The display system according to the present embodiment is configured as a part of the analysis system according to the present embodiment. More specifically, the display system according to the present embodiment is used to display an analysis result of the analysis system according to the present embodiment to a user.

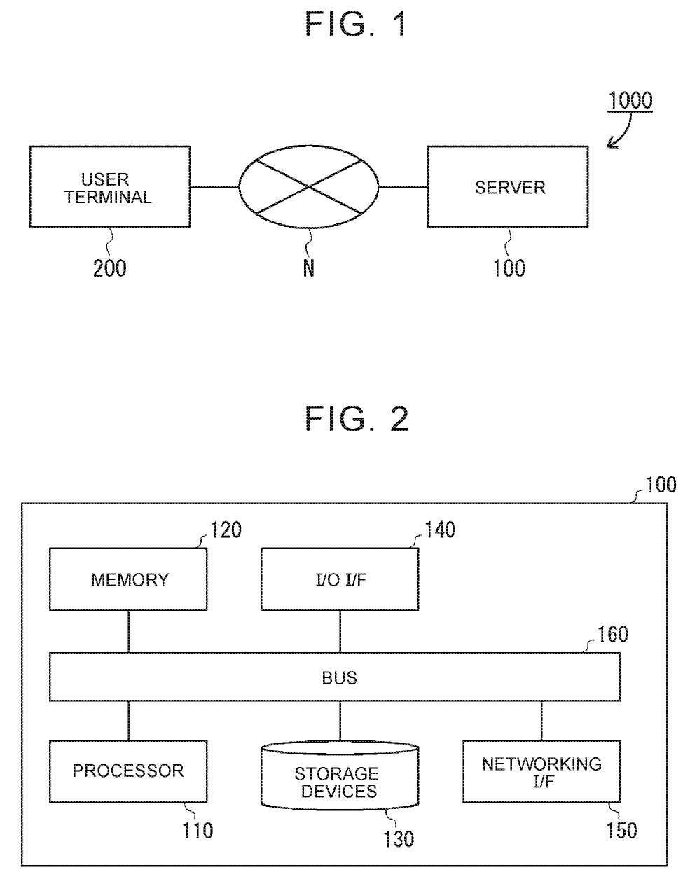

FIG. 1 is a block diagram illustrating a configuration of an analysis system according to a first embodiment. As illustrated in FIG. 1, the analysis system 1 according to the present embodiment is connected to a server 100 and a user terminal 200 via a network N such as the Internet.

The analysis system 1 is a system for extracting feature amounts from a plurality of pieces of image data. Although the image data to be analyzed by the analysis system 1 is not particularly limited, for example, an image captured by a fixed-point camera or the like installed outdoors may be used as an analysis target.

The analysis system 1 according to the present embodiment may perform feature amount extraction from image data having the same background or image data captured by a fixed-point camera, for example.

Although the details will be described later, the analysis system 1 according to the present embodiment corrects the position of a plurality of pieces of image data such that the positions of the common portions coincide with each other, thereby correcting the misalignment caused when the image data is captured. Therefore, the analysis system 1 according to the present embodiment has a special effect when extracting a feature amount from image data having the same background or image data captured by a fixed-point camera.

The analysis system 1 according to the present embodiment may be provided, for example, as a part of a data cloud type service used in material development or research and development. In addition, it may be used as a so-called material informatics (MI, Materials Informatics) or a system for promoting R&D using data science.

The image data analyzed by the analysis system 1 in the above cases includes, for example, image data captured using an optical microscope, a scanning electron microscope (SEM, Scanning Electron Microscope), a transmission electron microscope (TEM, Transmission Electron Microscope), a computed tomography (CT, Computed tomography), or the like.

In the analysis system 1, the user terminal 200 transmits image data to the server 100, and the server 100 analyzes the received image data. Then, the server 100 transmits the analysis result to the user terminal 200, and displays the analysis result received by the user terminal 200 to the user.

The user terminal 200 according to the present embodiment is a terminal operated by a user, and is typically a computer device having a display device.

The user terminal 200 transmits the image data to the server 100 via the network N. Then, the user terminal 200 receives the analysis result of the measurement data from the server 100 via the network N.

The server 100 according to the present embodiment receives image data from the user terminal 200 and analyzes the received image data. Then, the server 100 transmits the analysis result to the user terminal 200 via the network N.

FIG. 2 is a block diagram illustrating a hard configuration of the server according to the first embodiment.

As illustrated in FIG. 2, the server 100 includes a processor 110, a memory 120, a storage device 130, an input/output interface 140, a network interface 150, and an internal bus 160.

The internal bus 160 is a data transmission path through which the processor 110, the memory 120, the storage device 130, the input/output interface 140, and the network interface 150 transmit and receive data to and from each other. However, the method of connecting the processors 110 and the like to each other is not limited to the bus connection.

The memory 120 is a main storage device realized by using RAM (Random Access Memory).

The storage device 130 is an auxiliary storage device realized by using a hard disk, an SSD (Solid State Drive), a memory card, a ROM (Read Only Memory), or the like. The storage device 130 stores a program for realizing a desired function.

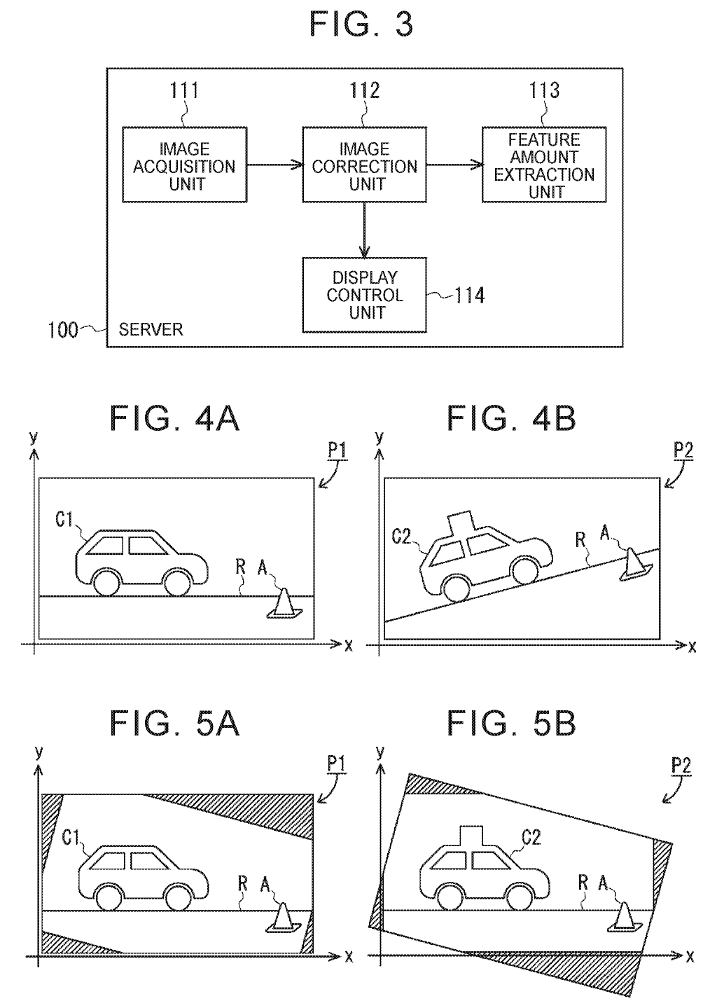

The processor 110 is a variety of processors, such as CPU (Central Processing Unit), GPU (Graphics Processing Unit), or FPGA (field-programmable gate array). The processor 110 reads a program stored in the storage device 130 into the memory 120 and executes the program, thereby executing a function as each functional block illustrated in FIG. 3 to be described later.

The input/output interface 140 is an interface for connecting the server 100 and the input/output device. For example, an input device such as a keyboard or an output device such as a display device may be connected to the input/output interface 140.

The network interface 150 is an interface for connecting the server 100 to a network.

It should be noted that the program includes instructions (or software code) for causing a computer to perform one or more of the functions described in the embodiments when loaded into the computer. The program may be stored in a non-transitory computer-readable medium or a tangible storage medium. By way of example, and not limitation, computer-readable media or tangible storage media include RAM, ROM, flash memory, SSD or other memory techniques, CD-ROM, DVD (digital versatile disc), Blu-ray disk or other optical disk storage, magnetic cassettes, magnetic tape, magnetic disk storage, or other magnetic storage devices. The program may be transmitted on a transitory computer readable medium or a communication medium. By way of example, and not limitation, transitory computer-readable media or communication media include electrical, optical, acoustic, or other forms of propagated signals.

FIG. 3 is a block diagram illustrating functions of the server 100 according to the first embodiment.

As illustrated in FIG. 3, the server 100 according to the present embodiment includes an image acquisition unit 111, an image correction unit 112, a feature amount extraction unit 113, and a display control unit 114 as functional blocks.

The image acquisition unit 111 acquires a plurality of pieces of image data. More specifically, the image acquisition unit 111 acquires a plurality of pieces of image data from the user terminal 200 via the network N. The image acquisition unit 111 outputs the plurality of acquired image data to the image correction unit 112.

Note that the image acquisition unit 111 does not need to acquire a plurality of pieces of image data by one reception. For example, the image acquisition unit 111 may acquire the image data in a plurality of times. In this case, the image acquisition unit 111 may store the acquired image data in the storage device 130 every time the image data is acquired. When analyzing the image data, the image acquisition unit 111 may read the image data to be analyzed from the storage device 130 and output the image data to the image correction unit 112.

The image acquisition unit 111 does not need to read all the image data stored in the storage device 130, and may read only the image data designated by the user and output the image data to the image correction unit 112.

That is, the image acquisition unit 111 may create a database in which the image data is stored. The image acquisition unit 111 according to the first embodiment may be configured such that the user can appropriately select the image data to be analyzed from the created database.

The image correction unit 112 acquires a plurality of pieces of image data from the image acquisition unit 111. The image correction unit 112 corrects the positions of the plurality of pieces of image data such that the positions of the common portions coincide with each other. The image correction unit 112 outputs the plurality of corrected image data to the feature amount extraction unit 113.

FIGS. 4A, 4B, 5A, and 5B are schematic image diagrams for explaining the image correction unit according to the first embodiment. More specifically, FIGS. 4A and 4B are diagrams showing specific examples of an image prior to performing correction, and FIGS. 5A and 5B are diagrams showing specific examples of an image after performing correction.

However, xy co-ordinates described in FIGS. 4A, 4B, 5A, and 5B are for convenience to indicate the position of the image, and none of them are part of the image.

The analysis system 1 according to the present embodiment defines the position in the images using xy coordinates as shown in FIGS. 4A, 4B, 5A, and 5B. In the present embodiment, "correcting the position of the image" may mean, for example, correcting coordinate information set in each image.

Each of the image P1 shown in FIG. 4A and the image P2 shown in FIG. 4B is an image obtained by photographing the road R on which the mark A is installed by a fixed-point camera. In addition, the vehicle C1 is reflected in the image P1, and the vehicle C2 is reflected in the image P2.

Here, the image P1 and the image P2 are images of the same road R as described above, but are captured with the photographing position of the camera shifted due to, for example, strong wind.

Here, as shown in FIG. 4A, the image P1 is an image obtained by taking an image of the road R while the camera is substantially level. On the other hand, the image P2 in FIG. 4B is an image captured while the camera is tilted with respect to the road R.

When a feature amount is extracted using an image group captured with a shift occurring in the imaging position of the camera, such as the image P1 and the image P2, a feature amount reflecting the shift in the imaging position of the camera may be extracted. Therefore, the analysis system 1 according to the present embodiment corrects the position of the image before performing the extraction of the feature amount.

As described above, FIG. 5A shows the image P1 after the image correction unit 112 performs the correction, and FIG. 5B shows the image P2 after the image correction unit 112 performs the correction. In FIGS. 5A and 5B, the image correction unit 112 according to the present embodiment corrects the position of the image P2 such that the positions of the roads R and the marks A, which are the same parts of both images, coincide with each other. According to such a configuration, the analysis system 1 according to the present embodiment can correct a shift occurring when image data is captured. As a result, the analysis system 1 according to the present embodiment can improve the extraction accuracy of the feature amount.

More specifically, for example, the image correction unit 112 according to the present embodiment may perform unsupervised learning on the image P1 and P2, and extract the road R and the mark A that are shared subjects. Then, the position of the image P2 may be corrected such that the positions of the roads R and the marks A, which are shared subjects, coincide with each other in the image.

In addition, the image correction unit 112 according to the present embodiment may perform masking processing on at least a part of a region that does not correspond to a common portion at an outer edge portion of the image data.

In other words, the image correction unit 112 according to the present embodiment may prevent at least a part of a region located at an outer edge portion of the image data and not corresponding to a common portion from being an object of feature amount extraction.

For example, in FIGS. 5A and 5B, the image correction unit 112 may mask the hatched area in the diagram so as not to be an object of feature-quantity extracting.

According to such a configuration, the analysis system 1 according to the present embodiment can further suppress the difference in the position information caused by the deviation of the camera. Further, according to such a configuration, the analysis system 1 according to the present embodiment can extract a feature amount from a region other than the outer edge portion, that is, a region that is highly likely to be a target of comparison verification between a plurality of images. Therefore, the difference between significant images can be reflected in the feature amount. As a result, the analysis system 1 according to the present embodiment can further improve the extraction accuracy of the feature amount.

The feature amount extraction unit 113 acquires the corrected image data from the image correction unit 112. The feature amount extraction unit 113 extracts a feature amount from the corrected image data. Note that the extracted feature amount is used for various analyses including, for example, regression analysis.

The feature amount extraction unit 113 according to the present embodiment extracts a feature amount from image data in which a difference in position information caused by a deviation of a camera is suppressed by correction. Therefore, the feature amount extraction unit 113 according to the present embodiment can extract a feature amount with high significance.

Specifically, the feature amount extraction unit 113 may perform, for example, principal component analysis (PCA, Principle Component Analysis) on the image data. Then, the feature amount extraction unit 113 may extract the principal component and the principal component score as the feature amount.

More specifically, the feature amount extraction unit 113 may perform, for example, two-dimensional principal component analysis (2D-PCA, 2D Principle Component Analysis) on the corrected image data.

In the two-dimensional principal component analysis, since the image is directly processed as a two-dimensional matrix, position-specific information such as a luminance difference or a pattern change at a predetermined position is reflected in the feature amount.

As described above, the analysis system 1 according to the present embodiment can extract the feature amount while suppressing the influence of the difference in the position information caused by the deviation of the camera. Therefore, the analysis system 1 according to the present embodiment has a special effect when performing two-dimensional principal component analysis in which position-specific information is easily reflected in the feature amount.

The display control unit 114 acquires the plurality of corrected image data from the image correction unit 112. Then, the display control unit 114 displays the plurality of corrected image data to the user. More specifically, the display control unit 114 according to the present embodiment causes the display device included in the user terminal 200 to display the corrected image data.

In particular, the display control unit 114 according to the present embodiment displays a plurality of corrected image data to the user in order to allow the user to confirm whether or not the correction of the image data by the image correction unit 112 is appropriate.

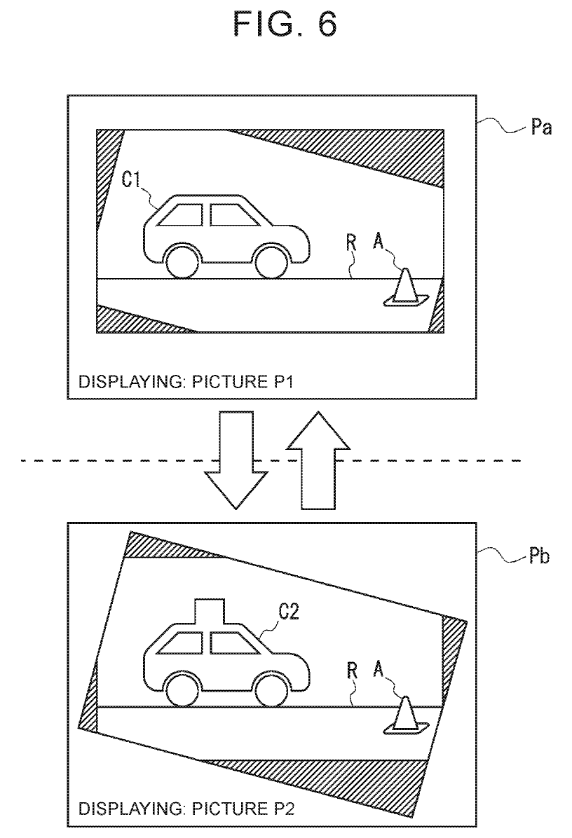

FIG. 6 is a schematic image plane view for explaining the display control unit according to the first embodiment. More specifically, FIG. 6 is a schematic diagram illustrating a display mode when the image P1 and the image P2 described with reference to FIGS. 4A, 4B, 5A, and 5B are displayed.

The screen Pa shown in FIG. 6 shows a display screen in which the image P1 is displayed. The screen Pb shown in FIG. 6 shows a display screen in which the image P2 is displayed. The display control unit 114 according to the present embodiment displays the screen Pa and the screen Pb in a switchable manner.

Here, in the screen Pa and the screen Pb, the positions of the intersections of the image P1 and the image P2 coincide with each other. That is, the display control unit 114 switches the image data to be displayed such that the display positions of the common portions coincide with each other.

Note that the display control unit 114 according to the present embodiment can also be said to switch between images to be displayed like a so-called para-cartoon (Flipbook).

According to such a configuration, the analysis system 1 according to the present embodiment can allow the user to easily confirm whether or not the correction of the image is appropriately performed.

When the user determines that the correction of the image is not appropriately performed, the analysis system 1 may re-execute the correction of the image.

Further, the analysis system 1 according to the present embodiment may perform extraction of the feature amount after the user determines that the correction of the image is appropriately performed.

As described above, the analysis system 1 according to the present embodiment corrects the positions of the plurality of image data such that the positions of the common portions coincide with each other. Then, the analysis system 1 according to the present embodiment extracts the feature amount from the plurality of corrected image data.

According to such a configuration, the analysis system 1 according to the present embodiment can extract the feature amount from the image data while suppressing the influence of the deviation generated when the image data is captured. As a result, the analysis system 1 according to the present embodiment can improve the extraction accuracy of the feature amount.

### Operation of the Analysis System

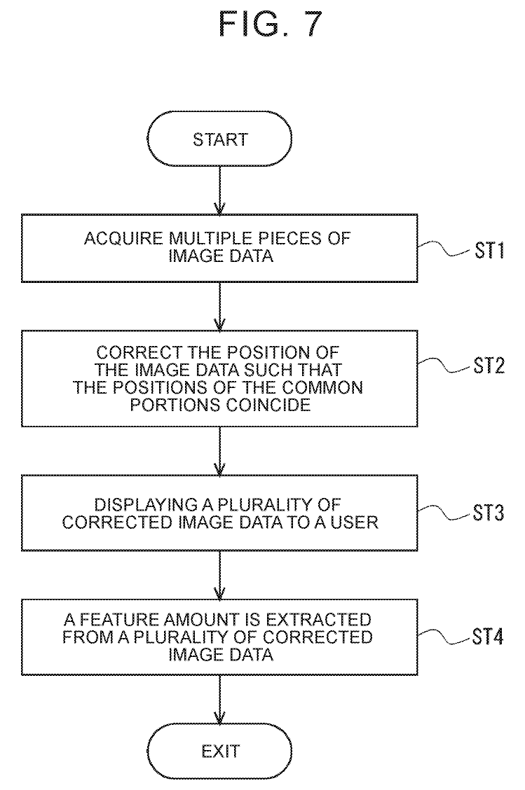

Next, the operation of the analysis system, that is, the analysis method according to the first embodiment will be described in detail. FIG. 7 is a flowchart illustrating an operation of the analysis system according to the first embodiment. In the following description, reference is made to FIGS. 1-6 as appropriate.

In the processing procedure of FIG. 7, the processor 110 reads the program stored in the storage device 130 into the memory 120 and executes the program. As a result, it functions as the image acquisition unit 111, the image correction unit 112, the feature amount extraction unit 113, and the display control unit 114.

In the analysis method according to the present embodiment, first, the processor 110 acquires a plurality of images (ST1). That is, in ST1, the processor 110 functions as the image acquisition unit 111.

The processor 110 then ST2 the positions of the plurality of images such that the positions of the intersections coincide. That is, in ST2, the processor 110 functions as the image correction unit 112.

With such a configuration, the analysis method according to the present embodiment can suppress the difference in the position information caused by the deviation of the camera. As a result, the analysis method according to the present embodiment can improve the extraction accuracy of the feature amount.

Note that, in ST2, the analysis system 1 according to the present embodiment may perform a masking process on at least a part of an area that does not correspond to a common part at an outer edge portion of the image data.

According to such a configuration, the analysis method according to the present embodiment can further suppress the difference in the position information caused by the deviation of the camera. Further, according to such a configuration, the analysis method according to the present embodiment can perform feature amount extraction on a region other than the outer edge portion, that is, a region that is highly likely to be a target of comparison verification between a plurality of images, and thus can reflect a difference between useful images in the feature amount. As a result, the analysis method according to the present embodiment can further improve the extraction accuracy of the feature amount.

The processor 110 then ST3 the corrected images to the user. That is, in ST3, the processor 110 functions as the display control unit 114.

More specifically, in ST3, the processor 110 switches the images to be displayed such that the display positions of the intersections coincide with each other.

According to such a configuration, the analysis system 1 according to the present embodiment can allow the user to easily confirm whether or not the correction of the image is appropriately performed.

When the user determines that the images are not appropriately corrected, the analysis system 1 according to the present embodiment may execute ST2 again.

Finally, the processor 110 extracts features from the plurality of corrected images (ST4), and the analysis system 1 according to the present embodiment ends the series of operations. That is, in ST4, the processor 110 functions as the feature amount extraction unit 113.

ST4 may be executed after the user determines that the images are appropriately corrected.

In the analysis method according to this embodiment, in ST4, the feature quantity is extracted from the image data in which the difference in the position information due to the deviation of the camera is suppressed. Therefore, the analysis method according to the present embodiment can extract a feature amount having high significance in analysis.

The present disclosure has been described with reference to the above embodiments. However, the present disclosure is not limited only to the configuration of the above embodiments, and it is of course to include various modifications, modifications, and combinations that may be made by a person skilled in the art within the scope of the claimed disclosure of the claims of the present application.

What is claimed is:

1. An analysis system comprising:
an image acquisition unit configured to acquire a plurality of pieces of image data;
an image correction unit configured to correct positions of the pieces of image data such that positions of common portions coincide with each other; and
a feature amount extraction unit configured to extract a feature amount from the corrected pieces of image data.

2. The analysis system according to claim 1, wherein the feature amount extraction unit is configured to perform principal component analysis on the pieces of image data to extract the feature amount from the pieces of image data.

3. The analysis system according to claim 1, wherein the image correction unit is configured to mask at least part of regions that do not correspond to the common portions at outer edges of the pieces of image data.

4. The analysis system according to claim 1, further comprising a display control unit configured to display the corrected pieces of image data for a user, wherein
the display control unit is configured to switch the pieces of image data to be displayed such that display positions of the common portions coincide with each other.

5. An analysis method comprising:
acquiring a plurality of pieces of image data;
correcting positions of the pieces of image data such that positions of common portions coincide with each other; and
extracting a feature amount from the corrected pieces of image data.
